(19) United States
(12) Patent Application Publication
(10) Pub. No.: US 2015/0045036 A1
(43) Pub. Date: Feb. 12, 2015

(54) SYSTEM AND METHOD FOR MANAGING TIME-TO-TRIGGER TIMERS IN MEASUREMENT REPORTING FOR A WIRELESS COMMUNICATION NETWORK

(71) Applicant: QUALCOMM Incorporated, San Diego, CA (US)

(72) Inventors: Sharif Ahsanul Matin, San Diego, CA (US); Mohamed Abdelrazek El-Saidny, Dubai (AE); Ahmad Amin Thalji, San Diego, CA (US); Tariq Alsheikh-Eid, San Diego, CA (US); Sitaramanjaneyulu Kanamarlapudi, San Diego, CA (US); Harish Venkatachari, Sunnyvale, CA (US); Shashank Vishwanatha Maiya, Sunnyvale, CA (US)

(73) Assignee: QUALCOMM Incorporated, San Diego, CA (US)

(21) Appl. No.: 14/196,072

(22) Filed: Mar. 4, 2014

Related U.S. Application Data
(60) Provisional application No. 61/864,400, filed on Aug. 9, 2013.

(51) Int. Cl. H04W 36/00; H04W 24/10

(52) U.S. Cl. CPC H04W 36/0088; H04W 24/10
USPC 455/437; 455/550.1

(57) ABSTRACT

Various aspects of the present disclosure provide methods and apparatuses that may provide for more efficient usage of time-to-trigger (TTT) timers in a wireless communication system, such that stopping or resetting of the TTT timer in response to receiving various measurement control messages (MCMs) can be limited to times when such stopping or resetting is appropriate.

### CROSS-REFERENCE TO RELATED APPLICATIONS

This application claims priority to and the benefit of provisional patent application No. 61/864,400 filed in the United States Patent Office on Aug. 9, 2013, the entire content of which is incorporated herein by reference.

### TECHNICAL FIELD

Aspects of the present disclosure relate generally to wireless communication systems, and more particularly, to measurement reporting and control in a UMTS Terrestrial Radio Access Network configured for high-speed downlink packet access (HSDPA).

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications. During serving cell change and handover, a UMTS network requests various measurement reports to be generated by a user equipment. Therefore, it is desirable to optimize or improve these measurement reporting processes.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure, nor to delineate the scope of any or all aspects of the disclosure. Its sole purpose is to present some concepts of one or more aspects of the disclosure in a simplified form as a prelude to the more detailed description that is presented later.

For example, a method and apparatus for wireless communication are disclosed, which may provide for more efficient usage of time-to-trigger (TTT) timers in HSDPA, such that stopping or resetting of the TTT timer in response to receiving various measurement control messages (MCMs) can be limited to times when such stopping or resetting is appropriate. For example, when an MCM is received, even if the Measurement ID of the MCM is the same as a Measurement ID for a running TTT timer, the user equipment may check one or more conditions before stopping or resetting the TTT timer, such as the event that the MCM sets up or modifies; whether the MCM modifies a core parameter; whether the MCM modifies a TTT timer value; and/or whether the MCM merely modifies a cell's neighbor list. In another example, a TTT timer may be enabled to start immediately after a cell satisfies a trigger condition for Event 1D (re-selection of serving HS-DSCH cell), even if that cell is not yet a member of the UE's Active Set.

One aspect of the disclosure provides a method of measurement reporting operable at a user equipment (UE). The UE starts a first time-to-trigger (TTT) timer for a first event, and the UE receives a measurement control message (MCM) while the first TTT timer is ongoing. If the MCM and the first TTT timer are associated with same identity information, the UE forgoes resetting the first TTT timer under at least one condition.

Another aspect of the disclosure provides an apparatus for wireless communication. The apparatus includes means for starting a first time-to-trigger (TTT) timer for a first event and means for receiving a measurement control message (MCM) while the first TTT timer is ongoing. The apparatus further includes means for, if the MCM and the first TTT timer are associated with same identity information, forgoing resetting the first TTT timer.

Another aspect of the present disclosure provides an apparatus for wireless communication. The apparatus includes at least one processor a communication interface coupled to the at least one processor, and a memory coupled to the at least one processor. The at least one processor includes a number of circuitries including first through third circuitries. The first circuitry is configured to start a first time-to-trigger (TTT) timer for a first event. The second circuitry is configured to receive a measurement control message (MCM) while the first TTT timer is ongoing. The third circuitry is configured to, if the MCM and the first TTT timer are associated with same identity information, forgo resetting the first TTT timer.

Another aspect of the disclosure provides a computer-readable medium, which includes code for causing a user equipment (UE) to perform various functions. The code causes the UE to start a first time-to-trigger (TTT) timer for a first event, and receive a measurement control message (MCM) while the first TTT timer is ongoing The code further causes the UE to if the MCM and the first TTT timer are associated with same identity information, forgo resetting the first TTT timer.

Another aspect of the disclosure provides a method of measurement reporting operable at a user equipment (UE). The UE measures a cell not a member of an active set. If a first condition to trigger a first event is satisfied based on a measurement of the cell, the UE starts a first TTT timer for the first event to transmit a measurement report causing the re-selection of the cell to be a best serving cell; and if a second condition to trigger a second event is satisfied based on the measurement, the UE starts a second TTT timer for the second event to add the cell to an active set. The first TTT timer and second TTT timer are at least partially overlapped in time duration.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a block diagram illustrating an example of a hardware implementation for an apparatus employing a processing system.

FIG. 2 is a block diagram conceptually illustrating an example of a telecommunications system.

FIG. 3 is a conceptual diagram illustrating an example of an access network.

FIG. 4 is a conceptual diagram illustrating an example of a radio protocol architecture for the user and control plane.

FIG. 5 is a block diagram conceptually illustrating an example of a Node B in communication with a user equipment in a telecommunications system.

FIG. 6 is a conceptual diagram illustrating Radio Resource Control (RRC) message flows between a user equipment and a network in a telecommunications system.

FIG. 7 is a flow chart illustrating a process for handling a measurement control message having its Measurement Command Information Element set to “modify” in accordance with some aspects of the present disclosure.

FIG. 8 is a flow chart illustrating a process for a user equipment (UE) for managing time-to-trigger (TTT) timers in accordance with aspects of the present disclosure.

FIG. 9 is a timeline illustrating UE behavior in relation to intra-frequency triggering events in accordance with one example.

FIG. 10 is a flow chart illustrating a process for a UE managing intra-frequency measurement TTT timers in accordance with some aspects of the present disclosure.

FIG. 11 is a timeline illustrating UE behavior in relation to intra-frequency triggering events in accordance with aspects of the disclosure.

FIG. 12 is a conceptual block diagram illustrating a UE configured to manage TTT timers in measurement reporting for a wireless communication network in accordance with an aspect of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

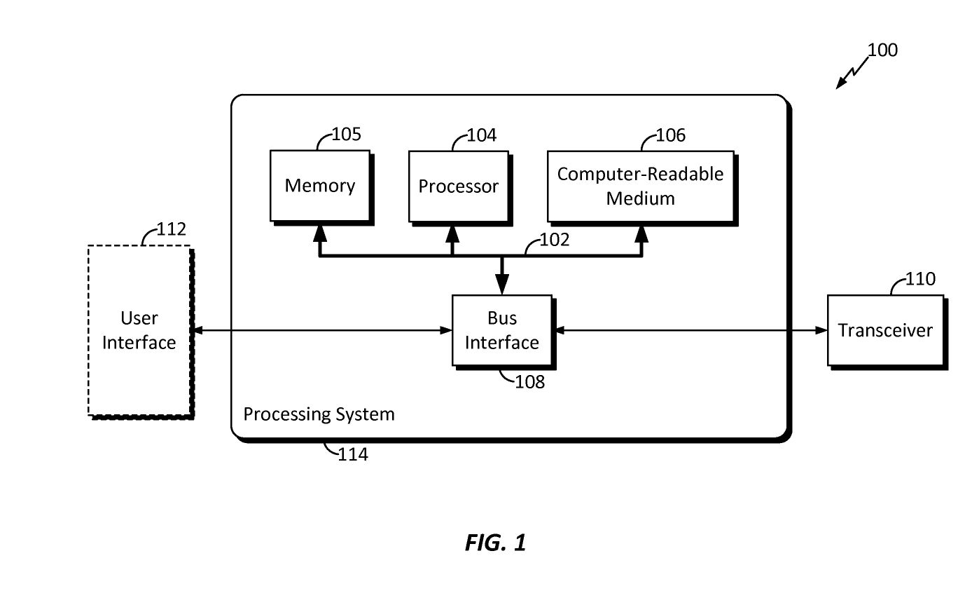

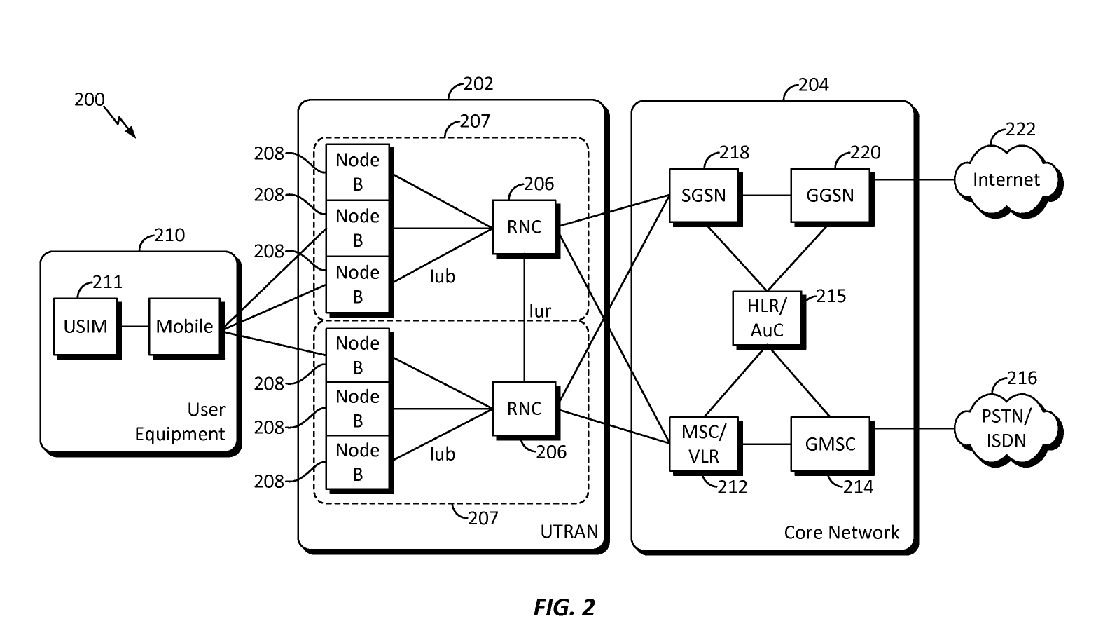

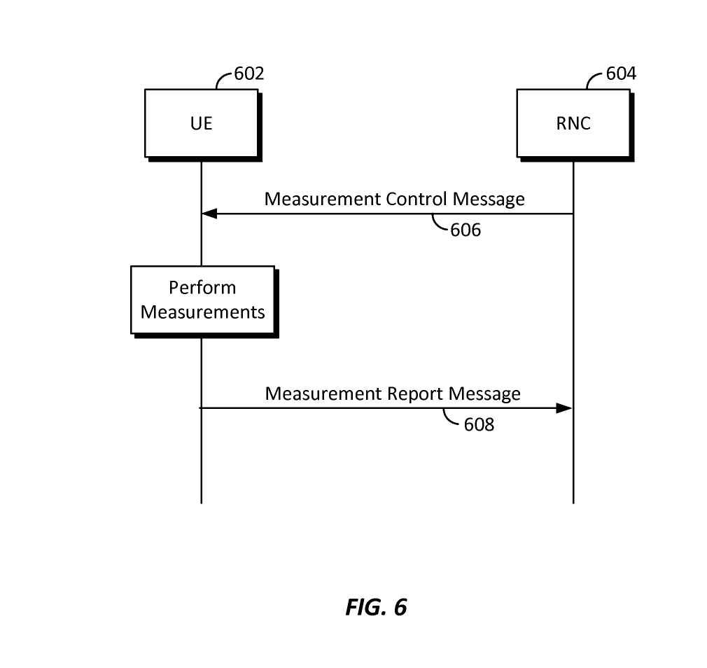

FIG. 1 is a conceptual diagram illustrating an example of a hardware implementation for an apparatus 100 employing a processing system 114. In accordance with various aspects of the disclosure, an element, or any portion of an element, or any combination of elements may be implemented with a processing system 114 that includes one or more processors 104. For example, the apparatus 100 may be a user equipment (UE) as illustrated in any one or more of FIGS. 2, 3, 5, 6, and/or 12. Examples of processors 104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. That is, the processor 104, as utilized in an apparatus 100, may be used to implement any one or more of the processes described below and illustrated in FIGS. 6-11.

In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors (represented generally by the processor 104), a memory 105, and computer-readable media (represented generally by the computer-readable medium 106). The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick, touchpad, touchscreen) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

One or more processors 104 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 106. The computer-readable medium 106 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium 106 may reside in the processing system 114, external to the processing system 114, or distributed across multiple entities including the processing system 114. The computer-readable medium 106 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The various concepts presented throughout this disclosure may be implemented across a broad variety of telecommunication systems, network architectures, and communication standards. Referring now to FIG. 2, as an illustrative example without limitation, various aspects of the present disclosure are illustrated with reference to a Universal Mobile Telecommunications System (UMTS) system 200. A UMTS network includes three interacting domains: a core network 204, a radio access network (RAN) (e.g., the UMTS Terrestrial Radio Access Network (UTRAN) 202), and a user equipment (UE) 210. Among several options available for a UTRAN 202, in this example, the illustrated UTRAN 202 may employ a W-CDMA air interface for enabling various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the illustrated RNCs 206 and RNSs 207. The RNC 206 is an apparatus responsible for, among other things, assigning, reconfiguring, and releasing radio resources within the RNS 207. The RNC 206 may be interconnected to other RNCs (not shown) in the UTRAN 202 through various types of interfaces such as a direct physical connection, a virtual network, or the like using any suitable transport network.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a core network 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The downlink (DL), also called the forward link, refers to the communication link from a Node B 208 to a UE 210 and the uplink (UL), also called the reverse link, refers to the communication link from a UE 210 to a Node B 208.

The core network 204 can interface with one or more access networks, such as the UTRAN 202. As shown, the core network 204 is a UMTS core network. However, as those skilled in the art will recognize, the various concepts presented throughout this disclosure may be implemented in a RAN, or other suitable access network, to provide UEs with access to types of core networks other than UMTS networks.

The illustrated UMTS core network 204 includes a circuit-switched (CS) domain and a packet-switched (PS) domain. Some of the circuit-switched elements are a Mobile services Switching Centre (MSC), a Visitor Location Register (VLR), and a Gateway MSC (GMSC). Packet-switched elements include a Serving GPRS Support Node (SGSN) and a Gateway GPRS Support Node (GGSN). Some network elements, like EIR, HLR, VLR, and AuC may be shared by both of the circuit-switched and packet-switched domains.

In the illustrated example, the core network 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a visitor location register (VLR) that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The illustrated core network 204 also supports packet-switched data services with a serving GPRS support node (SGSN) 218 and a gateway GPRS support node (GGSN) 220. General Packet Radio Service (GPRS) is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

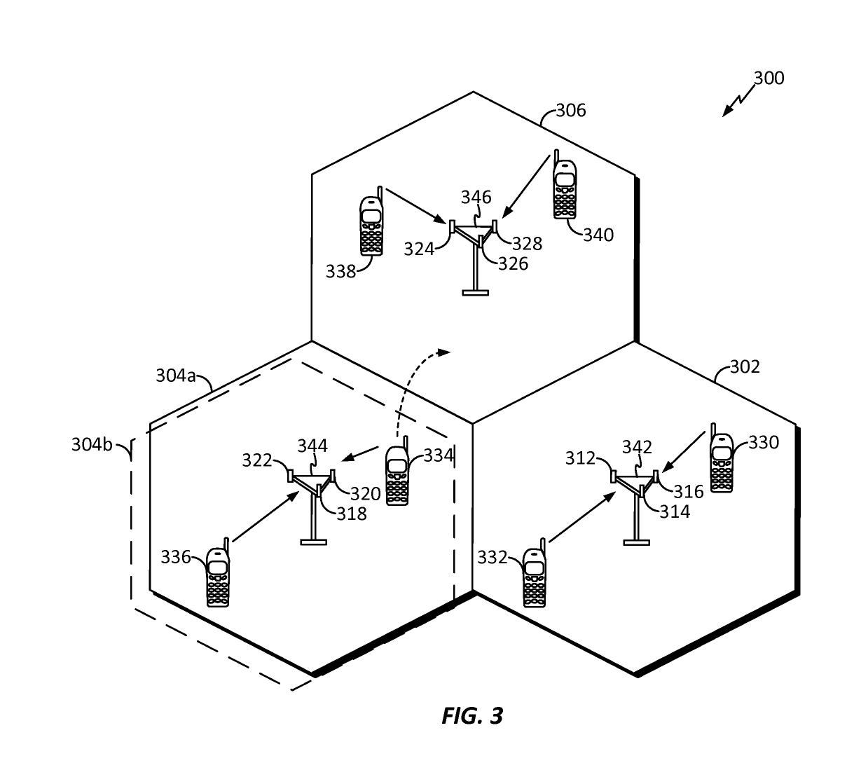

The UTRAN 202 is one example of a RAN that may be utilized in accordance with the present disclosure. Referring to FIG. 3, by way of example and without limitation, a simplified schematic illustration of a RAN 300 in a UTRAN architecture is illustrated. The system includes multiple cellular regions (cells), including cells 302, 304, and 306, each of which may include one or more sectors. Cells may be defined geographically (e.g., by coverage area) and/or may be defined in accordance with a frequency, scrambling code, etc. That is, the illustrated geographically-defined cells 302, 304, and 306 may each be further divided into a plurality of cells, e.g., by utilizing different scrambling codes. For example, cell 304a may utilize a first scrambling code, and cell 304b, while in the same geographic region and served by the same Node B 344, may be distinguished by utilizing a second scrambling code.

In a cell that is divided into sectors, the multiple sectors within a cell can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 may each correspond to a different sector. In cell 306, antenna groups 324, 326, and 328 may each correspond to a different sector.

The cells 302, 304, and 306 may include several UEs that may be in communication with one or more sectors of each cell 302, 304, or 306. For example, UEs 330 and 332 may be in communication with Node B 342, UEs 334 and 336 may be in communication with Node B 344, and UEs 338 and 340 may be in communication with Node B 346. Here, each Node B 342, 344, and 346 may be configured to provide an access point to a core network 204 (see FIG. 2) for all the UEs 330, 332, 334, 336, 338, and 340 in the respective cells 302, 304, and 306.

During a call with a source cell, or at any other time, the UE 336 may monitor various parameters of the source cell as well as various parameters of neighboring cells. Further, depending on the quality of these parameters, the UE 336 may maintain communication with one or more of the neighboring cells. During this time, the UE 336 may maintain an Active Set (Aset), that is, a list of cells to which the UE 336 is simultaneously connected (i.e., the UTRAN cells that are currently assigning a downlink dedicated physical channel DPCH or fractional downlink dedicated physical channel F-DPCH to the UE 336 may constitute the Active Set).

The UTRAN air interface may be a spread spectrum Direct-Sequence Code Division Multiple Access (DS-CDMA) system, such as one utilizing the W-CDMA standards. The spread spectrum DS-CDMA spreads user data through multiplication by a sequence of pseudorandom bits called chips. The W-CDMA air interface for the UTRAN 202 is based on such DS-CDMA technology and additionally calls for a frequency division duplexing (FDD). FDD uses a different carrier frequency for the uplink (UL) and downlink (DL) between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles are equally applicable to a TD-SCDMA air interface or any other suitable air interface.

A high speed packet access (HSPA) air interface includes a series of enhancements to the 3G/W-CDMA air interface between the Node B 208 and the UE 210, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

The radio protocol architecture between the UE and the UTRAN may take on various forms depending on the particular application. An example for an HSPA system will now be presented with reference to FIG. 3, illustrating an example of the radio protocol architecture for the user and control planes between a UE and a Node B. Here, the user plane or data plane carries user traffic, while the control plane carries control information, i.e., signaling.

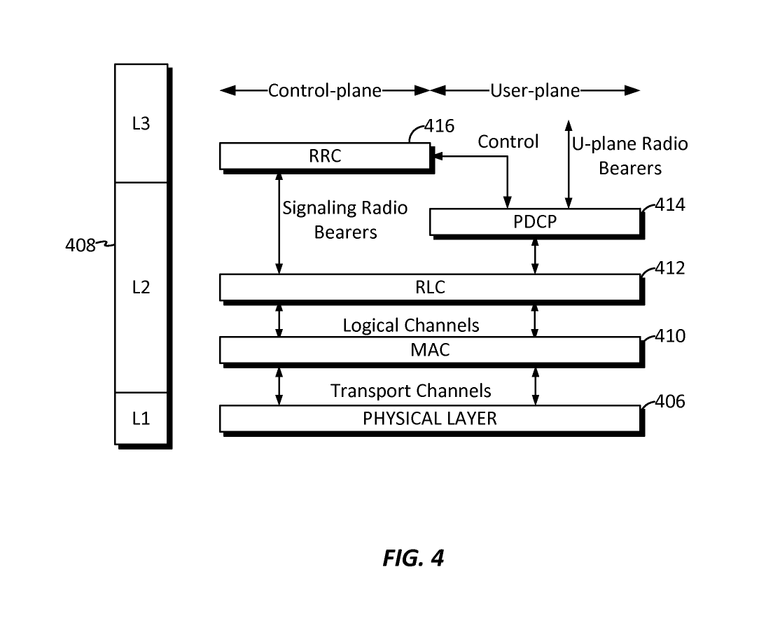

Turning to FIG. 4, the radio protocol architecture for the UE and Node B is shown with three layers: Layer 1, Layer 2, and Layer 3. Layer 1 is the lowest layer and implements various physical layer signal processing functions. Layer 1 will be referred to herein as the physical layer 406. The data link layer, called Layer 2 (L2 layer) 408 is above the physical layer 406 and is responsible for the link between the UE and Node B over the physical layer 406.

At Layer 3, the RRC layer 416 handles the control plane signaling between the UE and the RNC. RRC layer 416 includes a number of functional entities for routing higher layer messages, handling broadcast and paging functions, establishing and configuring radio bearers, etc.

In the UTRA air interface, the L2 layer 408 is split into sublayers. In the control plane, the L2 layer 408 includes two sublayers: a medium access control (MAC) sublayer 410 and a radio link control (RLC) sublayer 412. In the user plane, the L2 layer 408 additionally includes a packet data convergence protocol (PDCP) sublayer 414. Although not shown, the UE may have several upper layers above the L2 layer 408 including a network layer (e.g., IP layer) that is terminated at a PDN gateway on the network side, and an application layer that is terminated at the other end of the connection (e.g., far end UE, server, etc.).

The PDCP sublayer 414 provides multiplexing between different radio bearers and logical channels. The PDCP sublayer 414 also provides header compression for upper layer data packets to reduce radio transmission overhead, security by ciphering the data packets, and handover support for UEs between Node Bs.

The RLC sublayer 412 generally supports acknowledged, unacknowledged, and transparent mode data transfers, and provides segmentation and reassembly of upper layer data packets, retransmission of lost data packets, and reordering of data packets to compensate for out-of-order reception due to a hybrid automatic repeat request (HARQ). That is, the RLC sublayer 412 includes a retransmission mechanism that may request retransmissions of failed packets. Here, if the RLC sublayer 412 is unable to deliver the data correctly after a certain maximum number of retransmissions or an expiration of a transmission time, upper layers are notified of this condition and the RLC SDU may be discarded.

Further, the RLC sublayer at the RNC 206 (see FIG. 2) may include a flow control function for managing the flow of RLC protocol data units (PDUs). For example, the RNC may determine an amount of data to send to a Node B, and may manage details of that allocation including dividing the data into batches and distributing those batches or packets among multiple Node Bs in the case of downlink aggregation, e.g., in a DC-HSDPA system or a Multi-Point HSDPA system.

The MAC sublayer 410 provides multiplexing between logical and transport channels. The MAC sublayer 410 is also responsible for allocating the various radio resources (e.g., resource blocks) in one cell among the UEs, as well as HARQ operations. The MAC sublayer 410 can include various MAC entities, including but not limited to a MAC-d entity and MAC-hs/ehs entity.

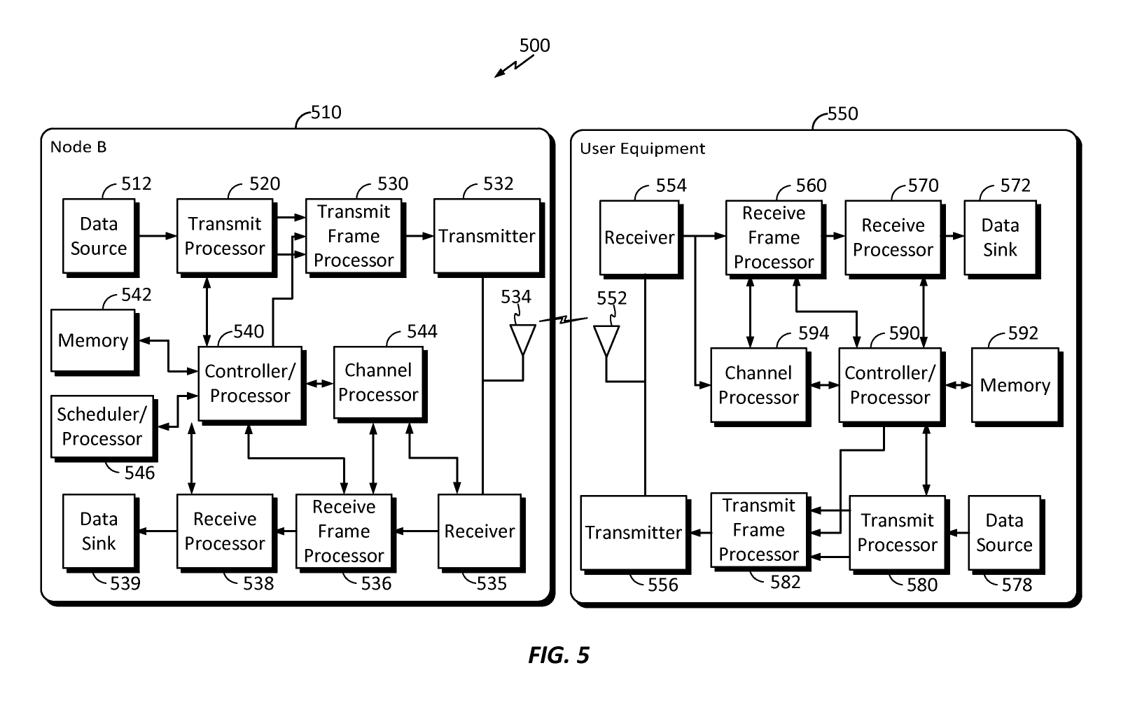

FIG. 5 is a block diagram of an exemplary Node B 510 in communication with an exemplary UE 550, where the Node B 510 may be the Node B 208 in FIG. 2, and the UE 550 may be the UE 210 in FIG. 2. In the downlink communication, a transmit processor 520 may receive data from a data source 512 and control signals from a controller/processor 540. The transmit processor 520 provides various signal processing functions for the data and control signals, as well as reference signals (e.g., pilot signals). For example, the transmit processor 520 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 544 may be used by a controller/processor 540 to determine the coding, modulation, spreading, and/or scrambling schemes for the transmit processor 520. These channel estimates may be derived from a reference signal transmitted by the UE 550 or from feedback from the UE 550. The symbols generated by the transmit processor 520 are provided to a transmit frame processor 530 to create a frame structure. The transmit frame processor 530 creates this frame structure by multiplexing the symbols with information from the controller/processor 540, resulting in a series of frames. The frames are then provided to a transmitter 532, which provides various signal conditioning functions including amplifying, filtering, and modulating the frames onto a carrier for downlink transmission over the wireless medium through antenna 534. The antenna 534 may include one or more antennas, for example, including beam steering bidirectional adaptive antenna arrays or other similar beam technologies.

At the UE 550, a receiver 554 receives the downlink transmission through an antenna 552 and processes the transmission to recover the information modulated onto the carrier. The information recovered by the receiver 554 is provided to a receive frame processor 560, which parses each frame, and provides information from the frames to a channel processor 594 and the data, control, and reference signals to a receive processor 570. The receive processor 570 then performs the inverse of the processing performed by the transmit processor 520 in the Node B 510. More specifically, the receive processor 570 descrambles and despreads the symbols, and then determines the most likely signal constellation points transmitted by the Node B 510 based on the modulation scheme. These soft decisions may be based on channel estimates computed by the channel processor 594. The soft decisions are then decoded and deinterleaved to recover the data, control, and reference signals. The CRC codes are then checked to determine whether the frames were successfully decoded. The data carried by the successfully decoded frames will then be provided to a data sink 572, which represents applications running in the UE 550 and/or various user interfaces (e.g., display). Control signals carried by successfully decoded frames will be provided to a controller/processor 590. When frames are unsuccessfully decoded by the receiver processor 570, the controller/processor 590 may also use an acknowledgement (ACK) and/or negative acknowledgement (NACK) protocol to support retransmission requests for those frames.

In the uplink, data from a data source 578 and control signals from the controller/processor 590 are provided to a transmit processor 580. The data source 578 may represent applications running in the UE 550 and various user interfaces (e.g., keyboard). Similar to the functionality described in connection with the downlink transmission by the Node B 510, the transmit processor 580 provides various signal processing functions including CRC codes, coding and interleaving to facilitate FEC, mapping to signal constellations, spreading with OVSFs, and scrambling to produce a series of symbols. Channel estimates, derived by the channel processor 594 from a reference signal transmitted by the Node B 510 or from feedback contained in the midamble transmitted by the Node B 510, may be used to select the appropriate coding, modulation, spreading, and/or scrambling schemes. The symbols produced by the transmit processor 580 will be provided to a transmit frame processor 582 to create a frame structure. The transmit frame processor 582 creates this frame structure by multiplexing the symbols with information from the controller/processor 590, resulting in a series of frames. The frames are then provided to a transmitter 556, which provides various signal conditioning functions including amplification, filtering, and modulating the frames onto a carrier for uplink transmission over the wireless medium through the antenna 552.

The uplink transmission is processed at the Node B 510 in a manner similar to that described in connection with the receiver function at the UE 550. A receiver 535 receives the uplink transmission through the antenna 534 and processes the transmission to recover the information modulated onto the carrier. The information recovered by the receiver 535 is provided to a receive frame processor 536, which parses each frame, and provides information from the frames to the channel processor 544 and the data, control, and reference signals to a receive processor 538. The receive processor 538 performs the inverse of the processing performed by the transmit processor 580 in the UE 550. The data and control signals carried by the successfully decoded frames may then be provided to a data sink 539 and the controller/processor, respectively. If some of the frames were unsuccessfully decoded by the receive processor, the controller/processor 540 may also use an acknowledgement (ACK) and/or negative acknowledgement (NACK) protocol to support retransmission requests for those frames.

The controller/processors 540 and 590 may be used to direct the operation at the Node B 510 and the UE 550, respectively. For example, the controller/processors 540 and 590 may provide various functions including timing, peripheral interfaces, voltage regulation, power management, and other control functions. The computer readable media of memories 542 and 592 may store data and software for the Node B 510 and the UE 550, respectively. A scheduler/processor 546 at the Node B 510 may be used to allocate resources to the UEs and schedule downlink and/or uplink transmissions for the UEs.

During a call with the source cell 304a (referring again to FIG. 3), or at any other time, the UE 336 may monitor various parameters of the source cell 304a as well as various parameters of neighboring cells such as cells 304b, 306, and 302. Depending on the quality of the parameters as measured, the UE 336 may maintain some level of communication with one or more of the neighboring cells. During this time, the UE 336 may maintain an Active Set, that is, a list of cells that the UE 336 is simultaneously connected to (i.e., the UTRA cells that are currently assigning a downlink dedicated physical channel DPCH or fractional downlink dedicated physical channel F-DPCH to the UE 336 may constitute the Active Set). Here, the cells in the Active Set can form a soft handover connection to the UE. The UE may additionally include a neighbor set or monitored set, including a list of cells that the UE may measure, but whose signal strength is not high enough to be included in the Active Set. For mobility management, the UE has to constantly or frequently measure or monitor the cells in the Active Set, as well as neighboring cells not belong to the Active Set. For example, the measurements include the received signal code power (RSCP) of the primary pilot channel (P-CPICH) and the P-CPICH chip signal-to-noise ratio (E_{c}/Nₒ).

Referring to FIG. 6, the measurements performed by a UE 602 may be controlled by an RNC 604 by using RRC messages 606 (e.g., Measurement Control Messages (MCMs)), which may indicate what to measure, when to measure, and how to report. In the 3GPP standard, the MCM may include various information to control UE measurements such as a measurement identity, a measurement command, and a measurement type. The UE 602 may be the UE 210 or UE 550, and the RNC 604 may be the RNC 206. After performing measurements requested by the RNC, the UE 602 sends a Measurement Report Message (MRM) 608 to report the measurement results to the RNC.

Management of the Active Set can be enabled through the use of certain Radio Resource Control (RRC) messages between the RNC and UE. For example, the selection of cells to include in the Active Set or re-selection of a best cell may depend on certain UE measurements, which may be configured by the network in a system information block (SIB). For example, the UTRAN may control a measurement in the UE either by broadcast of System Information and/or by transmitting a Measurement Control message. Based on these measurements, the UE may transmit MRMs for certain reporting events (e.g., cell measurement event results). Within the measurement reporting criteria field in the Measurement Control message, the network notifies the UE which events should trigger a measurement report. Here, reporting events named Event 1a through Event 1d (e.g., e1a, e1b, e1c, and e1d) may correspond to intra-frequency measurements; and reporting events named Event 2a through Event 2d (e.g., e2a, e2b, e2c, and e2d) may correspond to inter-frequency measurements.

In the UMTS standard, a measurement quantity is used to evaluate whether an intra-frequency event has occurred or not. For example, the UE may measure a ratio between the signal strength and the noise floor (E_{c}/I₀) of a pilot signal (e.g., a common pilot channel CPICH) transmitted by each cell in the UE's monitored set. That is, the UE may determine the ratio E_{c}/I₀ for nearby cells, and may rank the cells based on these measurements.

When the ranking of a cell changes, or if any other reporting trigger or measurement event (known to those of ordinary skill in the art) occurs, the UE may, after a delay corresponding to a time-to-trigger (TTT) timer, send certain RRC messages to the RNC to report this event. For example, the RNC may make a decision to alter the Active Set for the UE, and send an RRC message (i.e., an Active Set Update message) to the UE indicating a change in the Active Set. The RNC may then communicate with the respective Node B or Node Bs, e.g., over an Iub interface utilizing Node B Application Part (NBAP) signaling to configure the cells for communication with the UE. Finally, the RNC may communicate with the UE utilizing further RRC messages, such as a Physical Channel Reconfiguration (PCR) message, with an RRC response from the UE of PCR Complete indicating success of the reconfiguration.

One reporting trigger may result when a primary CPICH enters the reporting range for the UE. That is, when the E_{c}/I₀ for a particular cell reaches a particular threshold (e.g., a certain number of dB below the E_{c}/I₀ of the primary serving cell) and maintains that level for a certain time such that it may be appropriate to add the cell to the Active Set. In this case, a reporting event called Event 1A (e1a) may occur.

Another reporting trigger may result when a primary CPICH leaves the reporting range. That is, when the E_{c}/I₀ for a particular cell falls below a particular threshold (e.g., a certain number of dB below the E_{c}/I₀ of the primary serving cell), and maintains that level for a certain time such that it may be appropriate to remove the cell from the Active Set. In this case, a reporting event called Event 1B (e1b) may occur.

Another reporting trigger may result when the Active Set is full, and a primary CPICH of a candidate cell outside the Active Set exceeds that of the weakest cell in the Active Set, such that it may be appropriate to replace the weakest cell in the Active Set with the candidate cell. Here, a reporting event called Event 1C (e1c) may occur, causing a combined radio link addition and removal.

In Release 5 of the 3GPP family of standards, High Speed Downlink Packet Access (HSDPA) was introduced. HSDPA utilizes as its transport channel the high-speed downlink shared channel (HS-DSCH), which may be shared by several UEs. The HS-DSCH is implemented by three physical channels: the high-speed physical downlink shared channel (HS-PDSCH), the high-speed shared control channel (HS-SCCH), and the high-speed dedicated physical control channel (HS-DPCCH).

The HS-DSCH may be associated with one or more HS-SCCH. The HS-SCCH is a physical channel that may be utilized to carry downlink control information related to the transmission of HS-DSCH. The UE may continuously monitor the HS-SCCH to determine when to read its data from the HS-DSCH, and the modulation scheme used on the assigned physical channel.

The HS-PDSCH is a physical channel that may be shared by several UEs. The HS-PDSCH may support quadrature phase shift keying (QPSK) and 16-quadrature amplitude modulation (16-QAM) and multi-code transmission.

The HS-DPCCH is an uplink physical channel that may carry feedback from the UE to assist the Node B in its scheduling algorithm. The feedback may include a channel quality indicator (CQI) and a positive or negative acknowledgement (ACK/NAK) of a previous HS-DSCH transmission.

One difference on the downlink between HSDPA and the previously standardized circuit-switched air-interface is the absence of soft handover in HSDPA. This means that HSDPA channels are transmitted to the UE from a single cell called the HSDPA serving cell. As the user moves, or as one cell becomes preferable to another, the HSDPA serving cell may change. Still, the UE may be in soft handover on the associated DPCH, receiving the same information from plural cells.

In Rel. 5 HSDPA, at any instance a UE has one serving cell, that being the strongest cell in the Active Set as according to the UE measurements of E_{c}/I₀. According to mobility procedures defined in Rel. 5 of 3GPP TS 25.331, the Radio Resource Control (RRC) signaling messages for changing the HSPDA serving cell are transmitted from the current HSDPA serving cell (i.e., the source cell), and not the cell that the UE reports as being the stronger cell (i.e., the target cell).

That is, in addition to the reporting triggers dealing with Event 1A and Event 1B, described above, for HSDPA, another reporting trigger may result when a neighbor cell (which may or may not be within the Active Set) exceeds the quality of the serving HS-DSCH cell according to the UE measurements of E_{c}/I₀. In this case it may be appropriate to re-select the serving HS-DSCH cell. Here, a reporting event called Event 1D (e1d) may occur, causing re-selection of the best serving HS-DSCH cell (i.e., change of best cell).

Although some differences may exist for inter-frequency handovers, as known to those having ordinary skill in the art, for the purpose of the present disclosure inter-frequency measurement events such as Event 2A through Event 2D are not described in detail herein. However, as will be apparent to those of ordinary skill in the art, one or more aspects of the present disclosure may be equally applied not only to the intra-frequency measurement events described above, but also to inter-frequency measurement events.

Moreover, various aspects of the present disclosure may apply to any measurement reporting message (MRM), not necessarily limited to the mobility events described above, but broadly including any MRM that may have an associated TTT timer.

In some scenarios, during the time that the UE may be generating one or more event-triggered reports (e.g., measurement report messages or MRMs), the UE may receive one or more measurement control messages (MCMs) from the network. In most cases, if an MCM is received while the UE is generating the measurement report, the UE may reset any ongoing time-to-trigger (TTT) timer associated with the measurement report, and start over again the generation of the measurement report, assuming that the conditions still satisfy the criteria for that particular measurement report. This often causes great delays in the reporting process. Sometimes, it may even eventually lead the reporting to such a degraded state that the UE can no longer reliably receive any signaling, causing call drops.

During a call (e.g., when the UE is in the CELL_DCH state of an RRC Connected Mode), MCMs can frequently appear in the downlink as a result of different Layer 3 procedures, UE movement, neighbor list updates of cells, etc. Most of the MCMs received while the UE is in the CELL_DCH state are neighbor list management-related modifications. In some networks, every single MCM transmitted to the UE includes the entire event definitions (e1a, e1b, etc.) without any real modification to a single parameter.

In some conventional UEs, if a TTT timer for an event is running (ongoing) but not yet expired, and an MCM is received with a “Measurement Command” information element (IE) set to “modify” (e.g., to change the reporting criteria), the UE only checks the corresponding Measurement Identity (ID) of the MCM. If the ID does not match the Measurement ID of the TTT timer, the UE does not do anything with the ongoing TTT timer (e.g., no resetting). This is the only condition typically implemented in a conventional UE that an ongoing TTT timer is not reset when the MCM is received. However, if the Measurement ID matches with the one for which a TTT timer is running, the conventional UE immediately resets the TTT timer value.

According to an aspect of the disclosure, the UE does not react to such MCM messages by stopping an ongoing TTT timer in certain conditions (e.g., predetermined conditions) even if the MCM message and TTT timer are associated with the same ID. In this way, measurement reporting delays may be reduced or avoided, resulting in faster and more effective report triggering, and potentially reducing or avoiding call drops or throughput loss due to late triggering of different events and/or serving cell change procedures.

For example, in the UMTS standard (e.g., 3GPP TS 25.331), there are many variations that an MCM with the same ID and “modify” command can have. The “modify” command is used to modify a previously defined measurement. In accordance with an aspect of the present disclosure, the UE may look at additional characteristics of the received MCM before disturbing or modifying any ongoing event or the associated timer, as described in further detail below. The 3GPP standards do not specify whether an ongoing TTT timer must be stopped, in the case that the received MCM has a Measurement Command IE set to “modify.” Therefore, the conventional behavior, wherein the TTT timer is reset, may be modified without varying from within the bounds of the 3GPP standards.

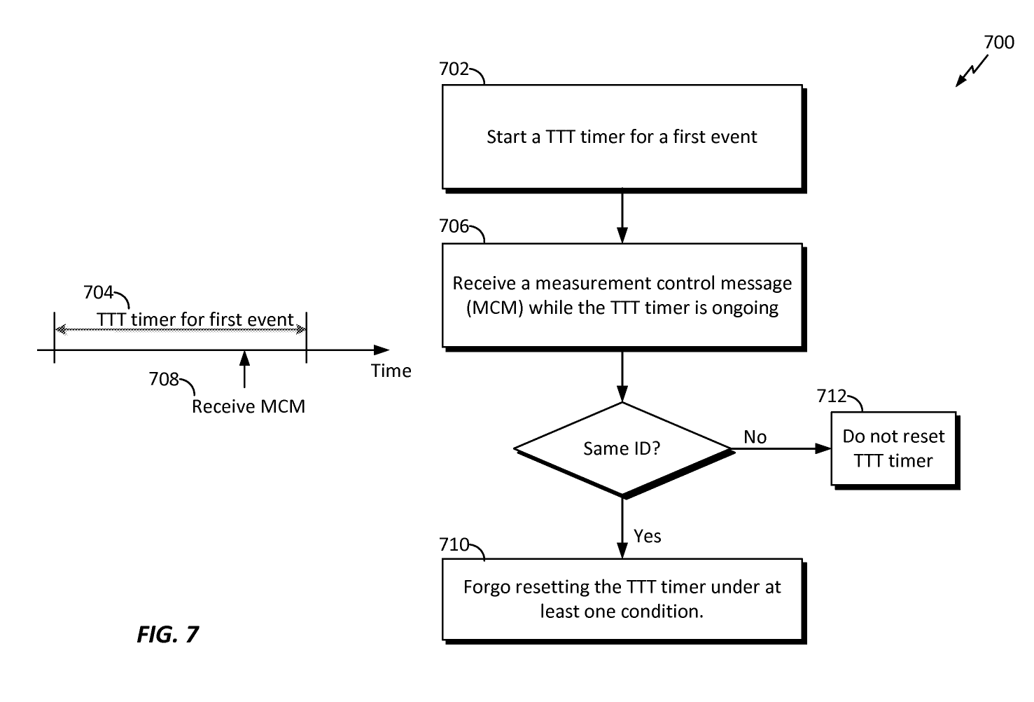

In accordance with some aspects of the disclosure, when the UE receives such an MCM having the Measurement Command IE set to “modify,” the UE may allow a TTT timer to continue to run, even in the case that the Measurement ID associated with the received MCM is the same as the Measurement ID associated with the running TTT timer. FIG. 7 is a flow chart illustrating a process 700 for a UE handling an MCM having its Measurement Command IE set to “modify” in accordance with some aspects of the present disclosure. The UE may be the UE 602 illustrated in FIG. 6 or any other suitable UEs. In block 702, the UE starts a TTT timer 704 associated with a first event. For example, the first event may be an intra-frequency measurement event (e.g., e1d). In block 706, the UE may receive a measurement control message (MCM) 708 while the TTT timer 704 is ongoing. If the MCM 708 and the TTT timer 704 are associated with the same identity information (e.g., measurement ID), the process continues to block 710; otherwise, the process continues to block 712. In block 710, the UE may forgo resetting the TTT timer 704 under at least one condition (e.g., a predetermined condition) that will be described in more detail below. In block 712, the UE does not reset the TTT timer 704 because the MCM and the first event are not associated with the same Measurement ID.

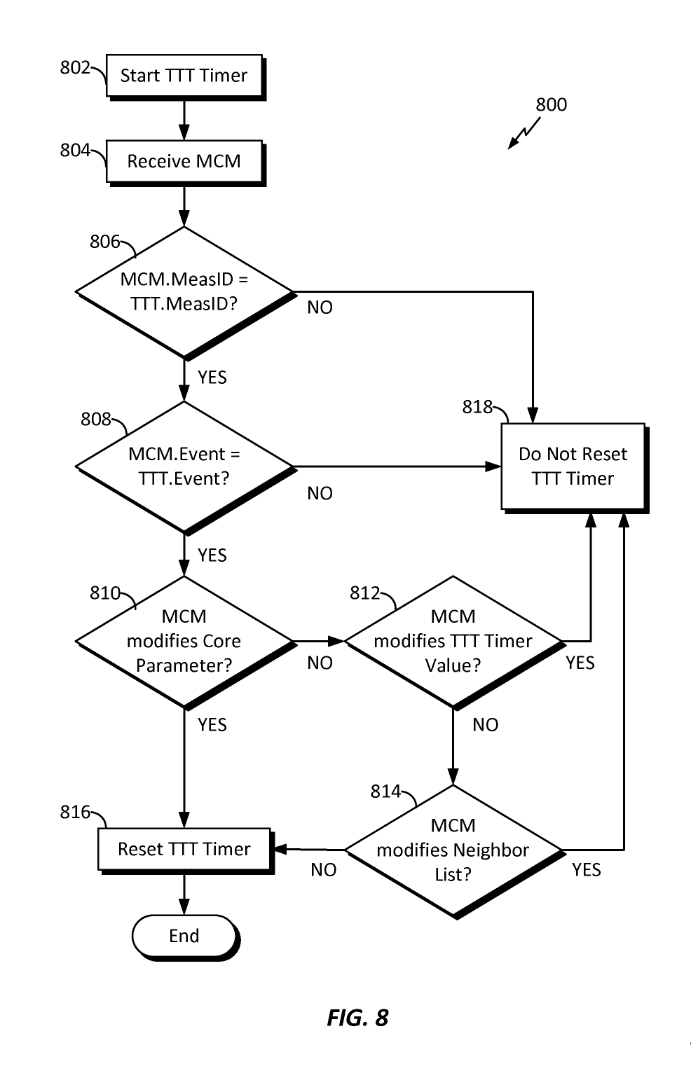

FIG. 8 is a flow chart illustrating a process 800 for a UE managing a TTT timer in accordance with some aspects of the present disclosure. In some aspects, the illustrated process may be performed by a processor 104 as illustrated in FIG. 1. In some aspects of the disclosure, the illustrated process may be performed by a UE such as the UE 210 illustrated in FIG. 2, the UE 550 illustrated in FIG. 5, or the UE 602 illustrated in FIG. 6. In other aspects of the disclosure, the illustrated process may be performed by any suitable apparatus for wireless communication.

In block 802, the UE may start a time-to-trigger (TTT) timer associated with the generation of a measurement report. As indicated above, any suitable measurement report may be the measurement report associated with the TTT timer. For example, the TTT timer may be associated with an intra-frequency measurement report (e.g., TTT timer 704 of FIG. 7). In block 804, the UE may receive a measurement control message (MCM) (e.g., MCM 708 of FIG. 7) having a “Measurement Command” IE set to “modify.”

In blocks 806-814, a series of determinations are shown at the UE, wherein in certain circumstances (e.g., predetermined conditions) the UE may move to block 818, wherein the UE does not reset the TTT timer (i.e., the TTT timer is allowed to continue to run), unlike the behavior in a conventional UE.

For example, in block 806, the UE may determine whether a measurement ID associated with the received MCM (MCM.MeasID) is the same as a measurement ID associated with the running TTT timer (TTT.MeasID). If not, then the process may proceed to block 818, wherein the TTT timer is not reset, as described above. As indicated above, in a conventional UE, this check in block 806 may be the only check performed on an incoming MCM; that is, if the MCM.MeasID=TTT.MeasID condition is met, then the conventional UE would generally reset the running TTT timer.

However, in an aspect of the disclosure, if MCM.MeasID is equal to TTT.MeasID, then the process may proceed to block 808, wherein the UE may determine whether the received MCM has the same Measurement ID, but sets up or modifies other events associated with the same Measurement ID. For example, a TTT timer may have been running for an Event 1D (e.g., a first event), but the newly received MCM may set up or modify an Event 1A (e.g., a second event), or some other reporting events. Here, if MCM.Event (an event associated with the MCM) is not equal to TTT.Event (an event associated with the TTT timer), then the process may proceed to block 818, wherein the TTT timer is not reset, as described above. However, in an aspect of the disclosure, if MCM.Event is equal to TTT.Event, then the process may proceed to block 810, wherein the UE may determine whether the received MCM has the same Measurement ID and also modifies the same Measurement Event, but does not modify one or more core parameters. Here, in some examples, core parameters may include parameters such as a filter coefficient, hysteresis, reporting range, etc., which may dictate or affect the triggering equation/condition or validity of an event as per 3GPP TS 25.331. For example, when the UE receives an IE “Filter coefficient” in an MCM, the UE may apply filtering of the measurements for the associated measurement quantity, and the filtering is performed by the UE before UE event evaluation. Because the filter coefficient is effective immediately, in an aspect of the disclosure, if the IE “Filter coefficient” is received in the MCM, the UE may consider it as a core parameter.

In another example, the 3GPP TS 25.331 specification describes one particular reporting event, Event 1D (change of best cell). This event is only applicable when the UE is in the CELL_DCH state. Upon transition to the CELL_DCH state, the UE sets “best cell’ in the variable BEST_CELL_{—}1D_EVENT to the best cell of the primary CPICHs included in the active set. In order to determine the best cell, the following equations may be used. The MCM may indicate the measurement quantity to be pathloss or CPICH-RSCP.

10·Log M_{NotBest}+CIO_{NotBest}≧10·Log M_{Best}+CIO_{Best}+H_{1d}/2 Equation 1 (Triggering condition for pathloss)

10·Log M_{NotBest}+CIO_{NotBest}≧10·Log M_{Best}+CIO_{Best}+H_{1d}/2 Equation 2 (Triggering condition for all the other measurement quantities)

The variables in the equations 1 and 2 are defined as follows:

M_{NotBest} is the measurement result of a cell not stored in “best cell” in the variable BEST_CELL_ID_EVENT.

CIO_{NotBest} is the cell individual offset of a cell not stored in “best cell” in the variable BEST_CELL_ID_EVENT.

M_{Best} is the measurement result of the cell stored in “best cell” in variable BEST_CELL_ID_EVENT.

CIO_{Best} is the cell individual offset of a cell stored in “best cell” in the variable BEST_CELL_ID_EVENT.

H_{1d} is the hysteresis parameter for the event 1d.

If the measurement results are pathloss or CPICH-E_{c}/Nₒ, then M_{NotBest} and M_{Best} are expressed as ratios.

If the measurement result is CPICH-RSCP, then M_{No Best} and M_{Best} are expressed in mW.

In a further aspect of the disclosure, each of the above parameters described in 3GPP TS 25.331, subsection 14.1.2.4, may be considered as “core parameters” corresponding to block 810. That is, because these parameters directly affect triggering equations/conditions or validity, as described above, they may be considered core parameters.

If the received MCM does modify a core parameter, the process may proceed to step 816, wherein the TTT timer may be reset. However, if not, the process may continue with further checks to determine whether to reset the TTT timer.

For example, at block 812, the UE may determine whether the received MCM modifies the TTT timer (for example enlarges it) of the same event, with the same ID. In this case, if the MCM merely modifies the TTT timer, then the process may proceed to block 818, and the TTT timer may not be reset. Here, rather than resetting the timer value, the UE may instead take leverage from already passed time on the TTT timer. (e.g., extending the length of the timer).

However, if the MCM does not merely modify the TTT timer value, the process may proceed to block 814, wherein the UE may determine whether the MCM merely modifies the neighbor list. In this case, even if the measurement ID and the event match, if the MCM merely modifies the neighbor list, then there is no need to reset the ongoing TTT timer. Thus, the process may proceed to block 818. However, in this example, if the MCM does not modify the neighbor list, having exhausted all the checks described above, the UE may reset the TTT timer in accordance with the received MCM.

In a further aspect of the disclosure, particularly relating to the generation of the Event 1D reporting event, the starting of the TTT timer for Event 1D may be enabled for a cell not in the UE's Active Set, as soon as the cell is strong enough for an Event 1D in the case that the cell were in the UE's Active Set.

That is, conventional networks may keep the UE's ability to report Event 1D (i.e., corresponding to a request to change the best cell in the UE's Active Set, as described above) confined to cells only within the UE's Active Set in their triggering condition. In other words, in some conventional networks, a UE cannot trigger Event 1D, to reselect the HS-DSCH serving cell, unless the new cell (i.e., best cell) is already added into the UE's Active Set.

However, in real-world operation, especially with mobility, it is possible that one or more cells in the Monitored Set or Neighbor Set, that are not within the UE's Active Set can be better than any member of the Active Set. In such scenarios, a conventional UE may wait until Event 1A is triggered and an Active Set Update is received from the network to have the cell within UE's Active Set, and only then would the Event 1D TTT timer be triggered. This can excessively delay the Event 1D procedure. Sometimes, especially for calls with a signaling radio bearer (SRB) on HS (e.g., in HSDPA), it can lead to a call drop. That is, in HSDPA, the serving cell is the only cell which feeds the SRB to the UE.

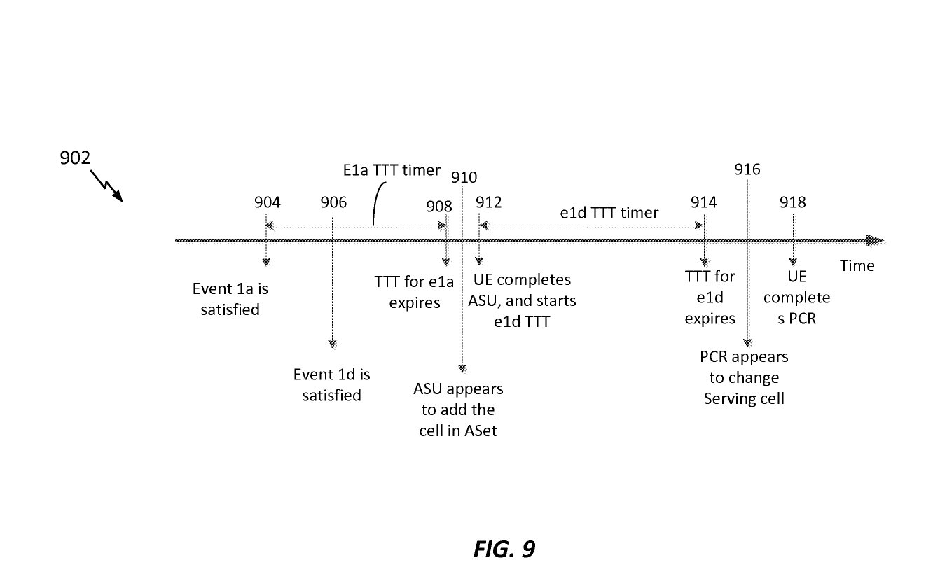

FIG. 9 illustrates a timeline for UE behavior in relation to an Event 1D in accordance with an example. At timeline 902, conventional UE behavior is illustrated, wherein the TTT timer associated with an Event 1D (e1d) is not started at the UE until after an Event 1A (e1a) is completed or triggered, and an Active Set Update is received, adding the cell to the UE's Active Set. In an example, at the time point 904, the condition for the Event 1A is satisfied here, and the UE starts an e1a TTT timer to add a cell into the Active Set. At the time point 906, the condition for an Event 1d is satisfied here for the same cell, but the UE cannot start an e1d TTT timer yet because this cell is not added to the Active Set yet. At the time point 908, the e1a TTT timer expires, and the UE may report an MRM for the Event 1A. At the time point 910, Active Set Update (ASU) appears to add the cell to the Active Set. At the time point 912, the UE completes ASU and starts the e1d TTT timer. At the time point 914, the e1d TTT timer expires, and the UE may report MRM for e1d. At the time point 916, the UE may receive a PCR message from the network to change the serving cell to the new best cell. In response, the UE may send a PCR Complete message at the time point 918.

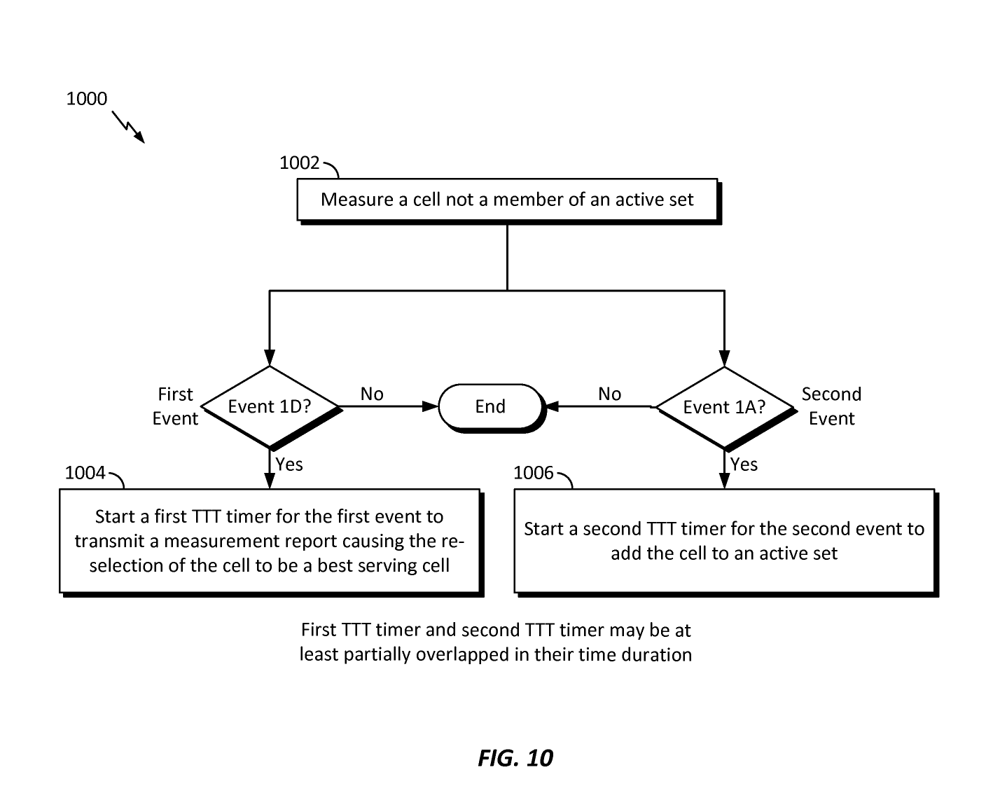

FIG. 10 is a flow chart illustrating a process 1000 for a UE managing TTT timers in accordance with some aspects of the present disclosure. In some aspects, the illustrated process may be performed by a processor 104 as illustrated in FIG. 1. In some aspects, the illustrated process may be performed by a UE such as the UE 210 illustrated in FIG. 2, the UE 550 illustrated in FIG. 5, or the UE 602 illustrated in FIG. 6. In other aspects of the disclosure, the illustrated process may be performed by any suitable apparatus for wireless communication.

In block 1002, the UE measures a cell that is not a cell included in an Active Set. That is, the cell is not a member of the Active Set. If the UE determines that the condition for triggering an Event 1D (first event) is met based on the measurement, the UE may start a first TTT timer to transmit a measurement report (e.g., MCM) causing the re-selection of the cell to be a best serving cell (block 1004). If the UE determines that the condition for triggering an Event 1A (second event) is met based on the measurement, the UE may start a second TTT timer to add the cell to an Active Set. The first TTT timer and second TTT timer may be at least partially overlapped in time duration. That is, one TTT timer may start while the other TTT timer is ongoing. Also, one TTT timer may expire while the other TTT timer is ongoing. In one aspect of the disclosure, the first TTT timer or second TTT timer may correspond to the TTT timer of block 802 illustrated in FIG. 8.

Therefore, in an aspect of the present disclosure, an Event 1D TTT timer may be enabled to run as soon as the measured cell is strong enough. That is, the UE needs not wait for the Active Set Update to appear and finish. The duration of the Event 1D TTT timer is usually much longer than that of the Event 1A TTT timer. In an aspect of the disclosure, the UE can expect that before the Event 1D TTT timer expires, Event 1A will be triggered and the cell will be added to the UE's Active Set to satisfy the Event 1D criteria. Therefore, immediately after the Active Set Update, the UE can report Event 1D.

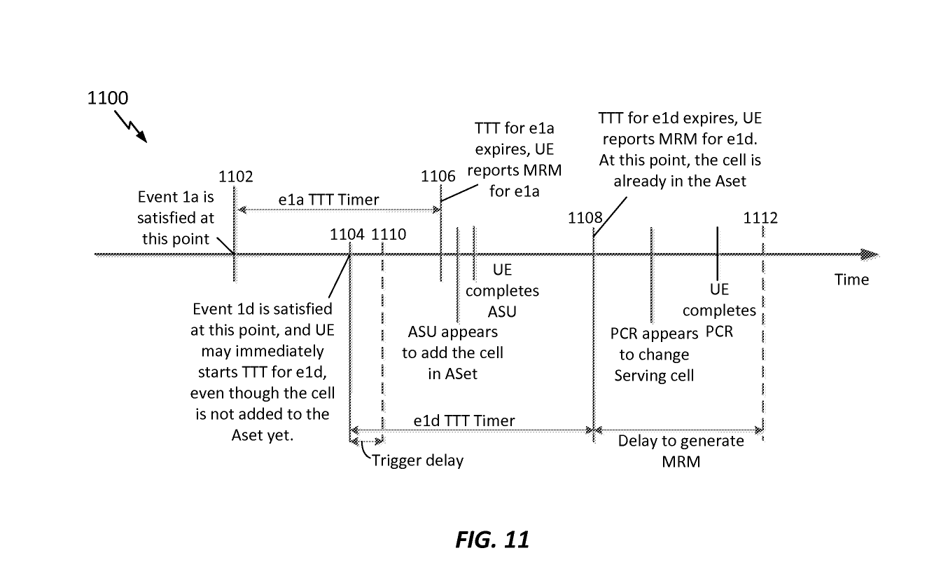

FIG. 11 is a timeline 1100 for UE behavior in relation to an Event 1D in accordance with an aspect of the disclosure. At the time point 1102, a trigger condition for an Event 1A is satisfied and an associated e1a TTT timer (first TTT timer) may start. Then, at the time point 1104, an e1d TTT timer (second TTT timer) associated with an Event 1D may begin immediately upon satisfaction of Event 1D criteria or trigger condition, even if the cell for which the Event 1D criteria are satisfied is not within the UE's Active Set. As illustrated in FIG. 11, especially in comparison with the timeline 902 illustrated in FIG. 9, at least a portion of the e1d TTT timer associated with the Event 1D may run in parallel or concurrently with the e1a TTT timer associated with the Event 1A. That is, the TTT timers may be at least partially overlapped in time duration. In this case, because the e1a TTT timer would be expected to expire (e.g., at the time point 1106) before the e1d TTT timer does at the time point 1108, the cell would be in the UE's Active Set by the time that the e1d TTT timer expires. Thus, when the e1d TTT timer expires, the UE can report the MRM for the Event 1D. Accordingly, the associated cell may be changed to the serving cell for the UE at an earlier time.

In a further aspect of the disclosure, the Event 1D cell may be added into the Active Set somewhere during the middle of the run of the e1d TTT timer. Otherwise, if the Event 1D cell is not added to the Active Set before the e1d TTT timer expires, the UE may block the report for the Event 1D. That is, the UE may refrain from generating the Event 1D report in such case.

In a still further aspect of the disclosure, the e1d TTT timer may be triggered or start at a time point 1110 after a suitable wait time (e.g., a delay) after its trigger condition is satisfied, in case the cell is still not added to the UE's Active Set. This TTT timer trigger delay can provide additional design flexibility. In another aspect of the disclosure, the UE may delay reporting the MRM for the Event 1D for a certain period of time. For example, the UE may report the MRM at the time point 1112. Delaying reporting MRM may be useful to ensure that the Event 1D cell is already a member of the Active Set.

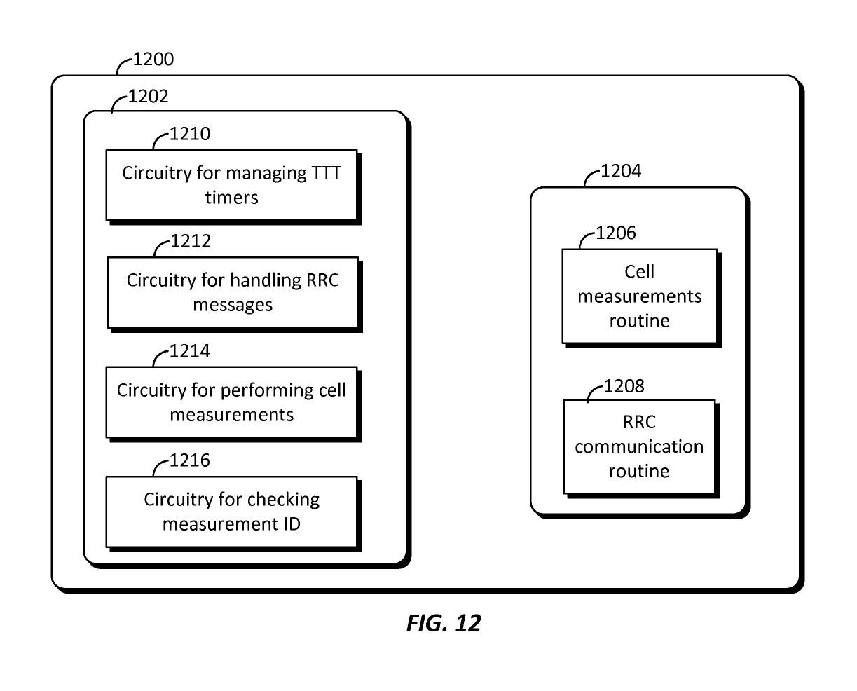

FIG. 12 is a conceptual block diagram illustrating a UE 1200 configured to manage TTT timers in measurement reporting for a wireless communication network in accordance with an aspect of the disclosure. The UE 1200 may be implemented with the apparatus 100. In some aspects of the disclosure, the UE 1200 may be any of the UEs illustrated in FIGS. 2, 3, 5, and 6. In some aspects of the disclosure, the UE 1200 may be configured to perform any of the processes illustrated in FIGS. 6-11.

The UE 1200 includes at least one processor 1202 and a computer-readable medium 1204. The processor 1202 includes various circuitries that may be configured by executing software stored in the computer-readable medium 1204 to perform various functions such as the those illustrated in FIGS. 6-11. In an aspect of the disclosure, the computer-readable medium 1204 includes a cell measurements routine 1206 for performing functions such as managing TTT timers and associated events in measurement reporting for a wireless communication network. For example, the TTT timers may be associated with various intra-frequency measurement events. The computer-readable medium 1204 also includes an RRC communication routine 1208. For example, this routine 1208 may handle measurement control messages and measurement report messages between the UE and a network.

Among the circuitries of the processor 1202, a first circuitry 1210 can be configured to manage TTT timers used in measurement reporting. The first circuitry 1210 may start, stop, set up, reset, and/or modify the TTT timers for different measurement events. In some aspects of the disclosure, the events may be intra-frequency measurement events (e.g., e1a, e1b, e1c, e1d, etc.). A second circuitry 1212 can be configured to handle RRC messages such as receiving measurement control messages (e.g., MCM 606) from the network and sending measurement report messages (e.g., MRM 608) to the network. A third circuitry 1214 can be configured to perform various cell measurements such as intra-frequency measurements described above and illustrated in FIGS. 6-11. A fourth circuitry 1216 can be configured to check and compare the measurement ID of TTT timers, measurements reports, and measurement control messages. It should be understood that the UE 1200 may include other components and circuitries such as those illustrated in the UEs of FIGS. 1 and 5, and the UE 1200 may also include components and circuitries that are generally known to be included in a UE. Each of the circuitries illustrated in FIG. 12 may be software, hardware, or a combination of software and hardware.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of measurement reporting operable at a user equipment (UE), comprising:
starting a first time-to-trigger (TTT) timer for a first event;
receiving a measurement control message (MCM) while the first TTT timer is ongoing; and
if the MCM and the first TTT timer are associated with same identity information, forgoing resetting the first TTT timer.

2. The method of claim 1, wherein, the MCM is configured to set up or modify a second event that is different from the first event.

3. The method of claim 1, wherein, the MCM is configured to modify parameters not affecting a triggering condition or validity of the first event.

4. The method of claim 3, wherein the parameters comprises at least one of a filter coefficient, a hysteresis, or a reporting range.

5. The method of claim 1, wherein, the MCM is configured to modify the duration of the first timer or a neighbor list.

6. The method of claim 1, wherein the first event comprises an intra-frequency measurement event.

7. The method of claim 1, further comprising:
starting the first TTT timer for the first event to transmit a measurement report causing the re-selection of a cell to be a best serving cell; and
starting a second TTT timer for a second event to add the cell to an active set,
wherein the first TTT timer and second TTT timer are at least partially overlapped in time duration.

8. An apparatus for wireless communication, comprising:
means for starting a first time-to-trigger (TTT) timer for a first event;
means for receiving a measurement control message (MCM) while the first TTT timer is ongoing; and
means for, if the MCM and the first TTT timer are associated with same identity information, forgoing resetting the first TTT timer.

9. The apparatus of claim 8, wherein, the MCM is configured to set up or modify a second event that is different from the first event.

10. The apparatus of claim 8, wherein, the MCM is configured to modify parameters not affecting a triggering condition or validity of the first event.

11. The apparatus of claim 10, wherein the parameters comprises at least one of a filter coefficient, a hysteresis, or a reporting range.

12. The apparatus of claim 8, wherein, the MCM is configured to modify the duration of the first timer or a neighbor list.

13. The apparatus of claim 8, wherein the first event comprises an intra-frequency measurement event.

14. The apparatus of claim 8, further comprising:
means for starting the first TTT timer for the first event to transmit a measurement report causing the re-selection of a cell to be a best serving cell; and
means for starting a second TTT timer for a second event to add the cell to an active set,
wherein the first TTT timer and second TTT timer are at least partially overlapped in time duration.

15. An apparatus for wireless communication, comprising:
at least one processor;
a communication interface coupled to the at least one processor; and
a memory coupled to the at least one processor,
wherein the at least one processor comprises:
first circuitry configured to start a first time-to-trigger (TTT) timer for a first event;
second circuitry configured to receive a measurement control message (MCM) while the first TTT timer is ongoing; and
third circuitry configured to, if the MCM and the first TTT timer are associated with same identity information, forgo resetting the first TTT timer.

16. The apparatus of claim 15, wherein, the MCM is configured to set up or modify a second event that is different from the first event.

17. The apparatus of claim 15, wherein, the MCM is configured to modify parameters not affecting a triggering condition or validity of the first event.

18. The apparatus of claim 17, wherein the parameters comprises at least one of a filter coefficient, a hysteresis, or a reporting range.

19. The apparatus of claim 15, wherein, the MCM is configured to modify the duration of the first timer or a neighbor list.

20. The apparatus of claim 15, wherein the first event comprises an intra-frequency measurement event.

21. The apparatus of claim 15, wherein the first circuitry is further configured to:
start the first TTT timer for the first event to transmit a measurement report causing the re-selection of a cell to be a best serving cell; and
start a second TTT timer for a second event to add the cell to an active set,
wherein the first TTT timer and second TTT timer are at least partially overlapped in time duration.

22. A computer-readable medium comprising code for causing a user equipment (UE) to:
start a first time-to-trigger (TTT) timer for a first event;
receive a measurement control message (MCM) while the first TTT timer is ongoing; and
if the MCM and the first TTT timer are associated with same identity information, forgo resetting the first TTT timer.

23. The computer-readable medium of claim 22, wherein, the MCM is configured to set up or modify a second event that is different from the first event.

24. The computer-readable medium of claim 22, wherein, the MCM is configured to modify parameters not affecting a triggering condition or validity of the first event.

25. The computer-readable medium of claim 24, wherein the parameters comprises at least one of a filter coefficient, a hysteresis, or a reporting range.

26. The computer-readable medium of claim 22, wherein, the MCM is configured to modify the duration of the first timer or a neighbor list.

27. The computer-readable medium of claim 22, wherein the first event comprises an intra-frequency measurement event.

28. The computer-readable medium of claim 22, wherein the code further causes the UE to:
start the first TTT timer for the first event to transmit a measurement report causing the re-selection of a cell to be a best serving cell; and
start a second TTT timer for a second event to add the cell to an active set,
wherein the first TTT timer and second TTT timer are at least partially overlapped in time duration.
